(19) United States
(12) Patent Application Publication
(10) Pub. No.: US 2012/0158469 A1
(43) Pub. Date: Jun. 21, 2012

(54) CONVERTING DIGITAL VOUCHERS TO TANGIBLE VOUCHERS

(75) Inventor: Beau N. Brewer, Salt Lake City, UT (US)

(73) Assignee: THE DEAL PICKLE, LLC, Salt Lake City, UT (US)

(21) Appl. No.: 13/328,766

(22) Filed: Dec. 16, 2011

Related U.S. Application Data
(60) Provisional application No. 61/423,970, filed on Dec. 16, 2010.
(60) Provisional application No. 61/480,435, filed on Apr. 29, 2011.

(51) Int. Cl. G06Q 30/02

(52) U.S. Cl. 705/14.1

(57) ABSTRACT

In some examples, a method of converting a digital voucher to a tangible voucher is described. The method may include receiving data indicating successful acquisition of a digital voucher from a voucher server. The method may also include receiving input effective to select the digital voucher for conversion to a tangible voucher. The method may also include sending data identifying the selected digital voucher and recipient data designating a recipient of the tangible voucher to the voucher server. The voucher server may be configured to coordinate production and delivery of the tangible voucher to the designated recipient.

### CROSS-REFERENCE TO RELATED APPLICATIONS

The present application claims the benefit of and priority to:

U.S. Provisional Application No. 61/423,970, filed Dec. 16, 2010 and entitled SYSTEMS AND METHODS FOR CONVERTING DIGITAL GIFT CERTIFICATES TO PHYSICAL GIFT CERTIFICATES; and

U.S. Provisional Application No. 61/480,435, filed Apr. 29, 2011 and entitled SYSTEMS AND METHODS FOR REDEEMING DIGITAL VOUCHERS.

Each of the foregoing applications is herein incorporated by reference in its entirety.

### BACKGROUND

1. Field of the Invention

Embodiments described herein generally relate to digital vouchers. More particularly, some example embodiments relate to converting digital vouchers to tangible vouchers.

2. Related Technology

Unless otherwise indicated herein, the materials described herein are not prior art to the claims in the present application and are not admitted to be prior art by inclusion in this section.

Recently, companies offering discount vouchers, such as coupons or gift certificates, have seen incredible growth. Typically, consumers visit a website or use a mobile application or other client application to browse and purchase the discount vouchers. Once an order for the discount voucher has been placed, the customer can print the voucher on a printer. Printed vouchers may be referred to herein as “tangible vouchers.”

Alternately, if the voucher was purchased using a mobile application, the customer can access the voucher within the mobile application on a corresponding smartphone or mobile computing device. Vouchers stored on and accessible through a smartphone or mobile computing device may be referred to herein as “digital” vouchers. Physical and digital vouchers may be generically referred to herein as “vouchers.”

Vouchers are redeemed by a corresponding issuing agency via a unique identifier, such as a barcode or number, that can be checked against a record of valid identifiers. While digital vouchers may be convenient for consumers in some respects, digital vouchers may be difficult to gift to a third party.

In addition, the ability for mobile devices to display and present digital vouchers provides companies leveraging these capabilities a number of advantages over traditional advertising and marketing methods. Advantages include speed of delivery, advanced targeting, flexibility, and cost savings. While some companies have developed their own digital voucher systems, most do not have the infrastructure or technology required to generate, store, deliver, and redeem digital vouchers.

Using a third-party company or provider for generating, storing, delivering and/or redeeming digital vouchers complicates the process of validating and redeeming the digital vouchers due to disparate systems that may be involved. A voucher may have a unique identifier (barcode, serial number, etc.) which may tie it to a voucher record in a database. The voucher record can contain the voucher's details including its validity and redemption status.

Some companies generate vouchers from within their own point-of-sale system or other internal system. When the voucher is presented for redemption, the point-of-sale system has access to the voucher records and is able to validate and mark the voucher as redeemed.

Other companies contract with a third-party provider for generating, storing, delivering and/or redeeming digital voucher. In these cases, voucher records may be generated and stored on a separate system from a company's point-of-sale system. When the voucher record is generated on a separate system, as is the case with a third-party provider, the point-of-sale system has no knowledge of the voucher record. In this scenario, the company may be provided with a list of voucher records in digital or print form so as to have access to the list of voucher records. When a consumer presents a voucher to the company for redemption, the company can find the matching record on the list and mark it as redeemed. However, it can be difficult to manage and keep the list current.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

Techniques described herein relate to converting digital vouchers to tangible vouchers.

In some examples, a method of converting a digital voucher to a tangible voucher is described. The method may include receiving data indicating successful acquisition of a digital voucher from a voucher server. The method may also include receiving input effective to select the digital voucher for conversion to a tangible voucher. The method may also include sending data identifying the selected digital voucher and recipient data designating a recipient of the tangible voucher to the voucher server. The voucher server may be configured to coordinate production and delivery of the tangible voucher to the designated recipient.

In some examples, a method of converting a digital voucher to a tangible voucher is described. The method may include receiving, from a client application, a request to convert a digital voucher to a tangible voucher, the request designating a recipient. The method may also include modifying a record corresponding to the digital voucher to reflect conversion of the digital voucher to the tangible voucher. The method may also include coordinating production and delivery of the tangible voucher to the designated recipient with a tangible voucher processor having production equipment.

In some examples, a method of converting a voucher record to a printable format suitable for production equipment is described. The method includes receiving a voucher record identifying a face value and unique identifier of a digital voucher purchased by a consumer and selected for conversion to a tangible voucher deliverable to a designated recipient. The method may also include converting the voucher record to a markup language document. The method may also include applying a collection of template rules to the markup language document to generate a formatted markup language document. The method may also include converting the formatted markup language document to an output document that is at least one of readable or printable. The method may also include sending the output document over a network to production equipment configured to generate the tangible voucher from the output document.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example operating environment in which digital vouchers may be redeemed and/or converted to tangible articles;

FIG. 2 illustrates an example of a smartphone that may be included in the operating environment of FIG. 1;

FIG. 3 illustrates an example of a tangible voucher that may be converted from a digital voucher;

FIG. 4 illustrates an example distributed processing architecture that may be implemented in the operating environment of FIG. 1;

FIGS. 5A-5C illustrate a communication device and aspects of a voucher application that may be executed by the communication device to convert digital vouchers to tangible vouchers;

FIG. 6A illustrates a portion of the operating environment of FIG. 1 and an example method of converting a digital voucher to a tangible voucher;

FIG. 6B illustrates a portion of the operating environment of FIG. 1 and another example method of converting a digital voucher to a tangible voucher;

FIG. 7 illustrates an example computing device configured to format voucher records into a format suitable for voucher production equipment;

FIG. 8A is a flowchart of an example method of converting a digital voucher to a tangible voucher;

FIG. 8B is a flowchart of another example method of converting a digital voucher to a tangible voucher;

FIG. 9 is a flowchart of an example method of converting a voucher record to a printable format suitable for production equipment;

FIG. 10 illustrates an example of a voucher database that may be implemented in the operating environment of FIG. 1;

FIG. 11 illustrates an example of a voucher redemption user interface that may be associated with a redemption application executed by a computer in the operating environment of FIG. 1;

FIG. 12 is a flowchart of an example method of redeeming digital vouchers;

FIG. 13 is a flowchart of another example method of redeeming digital vouchers;

FIG. 14 is a flowchart of another example method of redeeming digital vouchers; and

FIG. 15 is a block diagram illustrating an example computing device that is arranged for converting digital vouchers to tangible vouchers and/or redeeming digital vouchers,

all arranged in accordance with at least some embodiments described herein.

### DETAILED DESCRIPTION OF SOME EXAMPLE EMBODIMENTS

Some embodiments described herein relate to digital vouchers. For instance, some embodiments relate to converting digital vouchers to tangible vouchers and/or redeeming digital vouchers. The process of conversion may include operations to invalidate or remove the digital voucher from a communication device, queue the physical voucher for production, and the production of the physical voucher. Production and delivery time to a designated recipient may be streamlined by using a distributed processing network.

Digital vouchers may be presented on a communication device of a consumer to a merchant for redemption. Location data of the communication data may be captured to determine whether the digital voucher is being presented at a valid location. A time at which at the digital voucher is presented may also be captured. The location data and/or the time may be used to filter or sort a list of voucher records presented to the merchant to simplify a process of marking digital vouchers as redeemed.

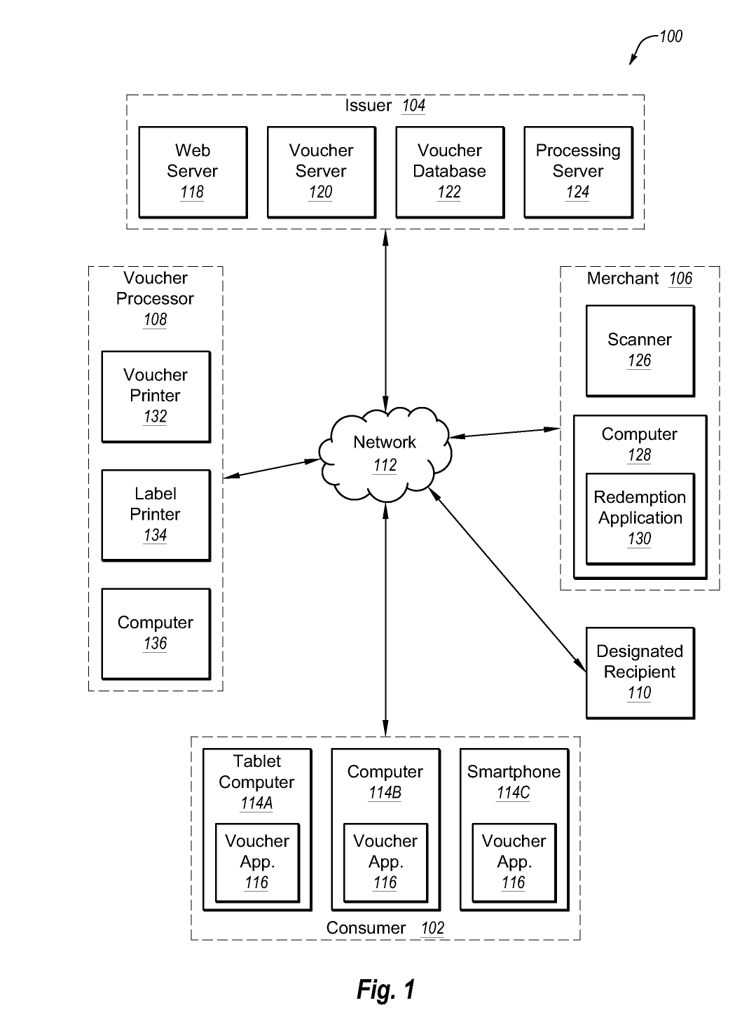

FIG. 1 illustrates an example operating environment 100 in which digital vouchers may be redeemed and/or converted to tangible vouchers, arranged in accordance with at least some embodiments described herein. The operating environment 100 may include or have operating therein one or more entities abstractly illustrated in FIG. 1, such as a consumer 102, an issuer 104, a merchant 106, a tangible voucher processor 108 (hereinafter “voucher processor 108”), and a designated recipient 110, collectively referred to hereinafter as “entities 102, 104, 106, 108, 110.” A brief overview of each of the entities 102, 104, 106, 108, 110 will first be provided followed by a more detailed description.

The consumer 102 purchases vouchers from the issuer 104. As used herein, the term “voucher” is to be broadly construed and may include, but is not limited to, gift certificates, coupons, and restricted monetary equivalents. The vouchers purchased by the consumer 102 from the issuer 104 may be digital vouchers and/or tangible vouchers. Digital vouchers include vouchers electronically stored on and accessible through a computing device associated with the consumer 102. Tangible vouchers include vouchers in any tangible form, such as a printed paper, magnetic-strip-type card, or the like or any combination thereof. While only a single consumer 102 is depicted in FIG. 1, more generally the operating environment 100 may include one or more consumers 102. Similarly, the operating environment 100 may include one or more designated recipients 110 although only a single designated recipient 110 is depicted in FIG. 1.

The issuer 104 sells vouchers to consumers 102. The vouchers may be associated with one or more merchants 106. The issuer 104 may electronically deliver digital vouchers to the consumer 102 and/or to the designated recipient 110 as desired by the consumer 102. Alternately or additionally, the issuer 104 may instruct the voucher processor 108 to generate and deliver tangible vouchers to the consumer 102 and/or to the designated recipient 110.

The merchant 106 offers goods and/or services to consumers 102 and designated recipients 110. Consumers 102 and designated recipients 110 may use digital or tangible vouchers to pay the merchant 106 for all or a portion of the goods or services. As such, the merchant 106 also redeems vouchers. As used herein, the term “merchant” is to be broadly construed herein to include a company and its employees and other company personnel.

The voucher processor 108 generates and distributes tangible vouchers to consumers 102 and/or designated recipients 110 as instructed by the issuer 104.

The designated recipient 110 receives digital and/or tangible vouchers purchased by a consumer 102. A given person may be both a designated recipient 110 and a consumer 102, or only one or the other.

With continued reference to FIG. 1, the operating environment 100 additionally includes a network 112 through which communication devices associated with the consumer 102, the issuer 104, the merchant 106, the voucher processor 108 and/or the designated recipient 110 may communicate. In general, the network 112 may include one or more wide area networks (WANs) and/or local area networks (LANs). In some embodiments, the network 112 includes the Internet, including a global internetwork formed by logical and physical connections between multiple WANs and/or LANs. Alternately or additionally, the network 112 may include one or more cellular RF networks and/or one or more wired and/or wireless networks such as, but not limited to, 802.xx networks, Bluetooth access points, wireless access points, IP-based networks, or the like. The network 112 may also include servers that enable one type of network to interface with another type of network.

FIG. 1 additionally illustrates various communication devices 114A, 114B, 114C (collectively “communication devices 114”) associated with the consumer 102. The communication devices 114 are examples of computing devices on which digital vouchers may be stored for and/or accessed by the consumer 102.

In the illustrated embodiment, the communication devices 114 include a tablet computer 114A, a desktop or laptop computer 114B, and a smartphone 114C. While FIG. 1 illustrates three associated communication devices 114, the consumer 102 may more generally have one or more associated communication devices 114. Moreover, each of the one or more communication devices 114 associated with the consumer 102 may include, but is not limited to, a mobile phone, a smartphone, a personal digital assistant (“PDA”), a personal pocket computer, a laptop computer, a desktop computer, a tablet computer, or any other electronic device configured to communicate with other electronic devices through a wired or wireless connection.

Each of the communication devices 114 may include a voucher application 116 that is executable by the communication devices 114 to perform one or more of the operations described in greater detail below. Briefly, for instance, the voucher application 116 may be executable by the corresponding communication device 114 to communicate with and receive vouchers from the issuer 104; to maintain a voucher vault including records of the consumer's 102 vouchers and synchronize the records with the issuer 104; to provide a user interface (UI) navigable by the consumer 102 to purchase vouchers, display received vouchers, and/or provide instructions and accept input for converting digital vouchers to tangible vouchers; and/or to communicate location data of the communication device 114 to the issuer 104 when a digital voucher is presented for redemption to the merchant 106. The foregoing list of operations that may be performed by the communication devices 114 by executing the voucher application 116 is provided by way of example only and is not intended to be either exhaustive or restrictive.

Various devices are also associated with the issuer 104, including a web server 118, a voucher server 120 and a voucher database 122. Optionally, a processing server 124 may also be associated with the issuer 104.

The web server 118 may host one or more websites or other content accessible by the communication devices 114 of the consumer 102 over the network 112 to acquire vouchers from the issuer 104. The web server 118 may communicate to the voucher server 120 to handle processing tasks such as creating, reading, updating, and/or deleting voucher records. The voucher records may be stored in memory on the voucher server 120 and/or on the separate voucher database 122.

In some embodiments, communications between the voucher server 120 and the communication devices 114 or between the voucher server 120 and devices associated with one or more of the merchant 106, the voucher processor 108 and the designated recipient 110 may be relayed by the web server 118. For instance, a request received from the consumer 102, or more particularly from one of the consumer's 102 communication devices 114, to convert a digital voucher to a tangible voucher may be received by the web server 118 and passed to the voucher server 120. The voucher server 120 may then update an associated voucher record in the voucher database 122 to reflect the conversion of the digital voucher to a tangible voucher.

The processing server 124, or in some cases the voucher server 120, may be configured to process the voucher record into a format that can be used by printers or other production equipment associated with the voucher processor 108. Processing the voucher record may include generating data in a page description language such as PostScript, Printer Job Language (PJL), Printer Command Language (PCL), InterPress, or ZPL. Processing the voucher record may alternately or additionally include generating a corresponding file that can be read or printed by the printer or other production equipment associated with the voucher processor 108; the generated file may include a portable document format (.pdf) file, a raw image file, or the like.

One or more devices are also associated with the merchant 106, including at least one of a scanner 126 and a computer 128. The scanner 126 may be configured to, among other things, scan barcodes on vouchers presented by consumers 102. In some embodiments, the scanner 126 may be communicatively coupled to the computer 128.

The computer 128 may include a special or general purpose computing device and may be implemented as a desktop computer, a laptop computer, a tablet computer, or other suitable computing device. In the illustrated embodiment, the computer 128 includes a redemption application 130 that is executable by the computer 128 to perform one or more of the operations described in greater detail below. Briefly, the redemption application 130 may be generally involved in the validation and redemption of vouchers by the merchant 106 and/or may be executable by the computer 128 to, e.g., present, on a display of the computer 128, a list of vouchers records to view, sort, filter, or mark as redeemed. The foregoing list of operations that may be performed by the computer 128 by executing the redemption application 130 is provided by way of example only and is not intended to be either exhaustive or restrictive.

One or more devices are also associated with the voucher processor 108, including at least one of a voucher printer 132, a label printer 134 and a computer 136. The voucher printer 132 may be configured to print tangible vouchers and optionally envelopes and/or labels for mailing the tangible vouchers to the consumers 102 and/or the designated recipients 110. Alternately or additionally, a separate label printer, such as the label printer 134, may be provided and configured to print envelopes and/or labels for mailing the tangible vouchers to the consumers 102 and/or the designated recipients 110. The voucher printer 132 and label printer 134 are examples of production equipment that may be associated with the voucher processor 108.

The computer 136 may include a special or general purpose computing device and may be implemented as a desktop computer, a laptop computer, a tablet computer, or other suitable computing device. The computer 136 may be configured to receive instructions, such as orders or requests to print tangible vouchers, from the issuer 104. The computer 136 may also be configured to provide corresponding print orders to the voucher printer 132 and/or the label printer 134.

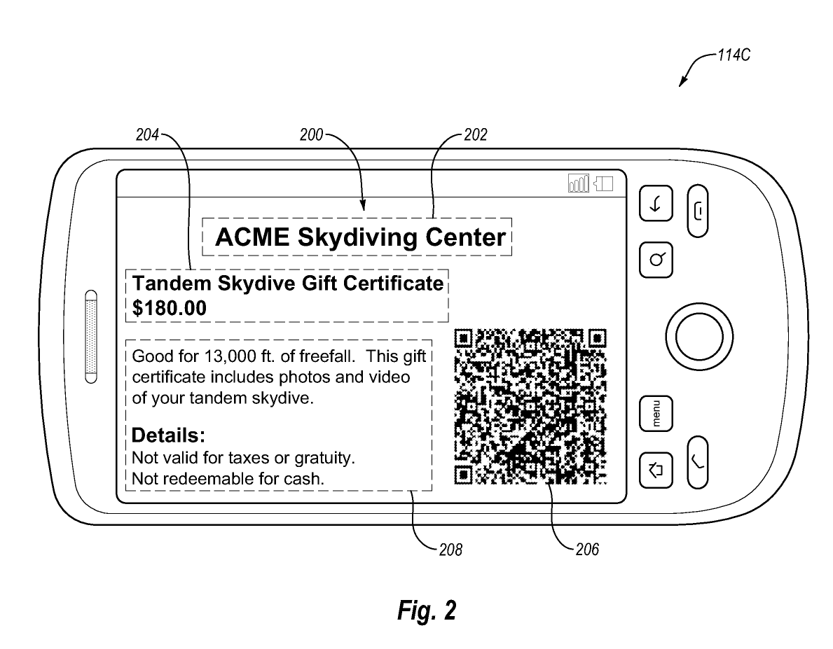

FIG. 2 illustrates an example of the smartphone 114C of FIG. 1, arranged in accordance with at least some embodiments described herein. FIG. 2 further illustrates an example of a digital voucher 200 presented, e.g., rendered, on a display (not labeled) of the smartphone 114C. In general, the digital voucher 200 may include one or more details of the digital voucher 200, such as, but not limited to, a merchant identifier 202 identifying a merchant at which the digital voucher 200 may be redeemed, a general description and face value 204 of the digital voucher 200, a unique identifier 206 of the digital voucher 200, a more detailed description and/or limitations 208 of the digital voucher 200, or the like or any combination thereof.

The specific merchant 202, general description and face value 204, unique identifier 206 and more detailed description and/or limitations 208 depicted in FIG. 2 are provided by way of example only and should not be construed as limiting. Moreover, although FIG. 2 illustrates the unique identifier 206 as a Quick Response (QR) code, more generally the unique identifier 206 may include a serial number, a one-dimensional barcode, a two-dimensional barcode such as that shown in FIG. 2, or the like or any combination thereof.

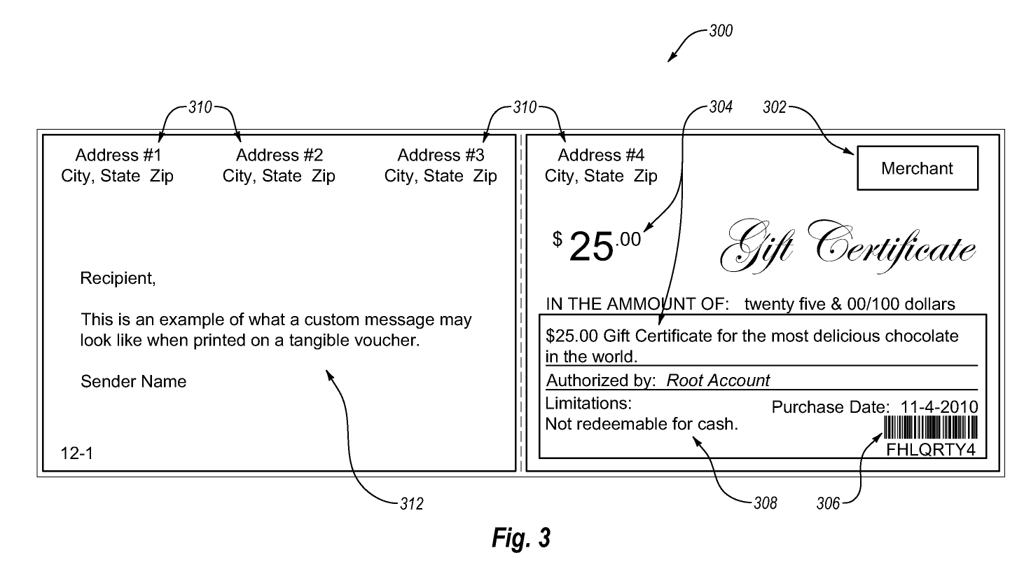

FIG. 3 illustrates an example of a tangible voucher 300, arranged in accordance with at least some embodiments described herein. As explained above, the consumer 102 may initially request a voucher in tangible form such as that illustrated in FIG. 3, or the consumer 102 may receive a digital voucher and subsequently request conversion of the digital voucher to a tangible voucher, such as the tangible voucher 300 illustrated in FIG. 3. The tangible voucher 300 may be shipped to a consumer or designated recipient by, e.g., the voucher processor 108 of FIG. 1.

Similar to the digital voucher 200 of FIG. 2, the tangible voucher 300 of FIG. 3 may include one or more details of the tangible voucher. For instance, in general, the tangible voucher 300 may include one or more of: a merchant identifier 302 identifying a merchant at which the tangible voucher 300 may be redeemed, a general description and face value 304 of the tangible voucher 300, a unique identifier 306 of the tangible voucher 300, a more detailed description and/or limitations 308 of the tangible voucher 300, or the like or any combination thereof.

Alternately or additionally, the tangible voucher 300 may further include location information 310 for one or more locations of the merchant identified by the merchant identifier 302 and/or a custom message 312. The custom message 312 may be provided by, e.g., the consumer 102 for the designated recipient 110 of FIG. 1 at the time the consumer 102 provides instructions to the issuer 104 for converting a corresponding digital voucher to the tangible voucher 300. Information such as location information 310 and/or a customer message 312 may alternately or additionally by provided in digital vouchers, such as the digital voucher 200 of FIG. 2.

According to some embodiments, a distributed processing architecture is implemented to deliver tangible vouchers to designated recipients. The distributed processing architecture may, in some embodiments, minimize a delivery time of tangible vouchers to designated recipients. More particularly, and with reference again to FIG. 1, multiple voucher processors 108 may be provided in the operating environment 100 distributed throughout a given region, such as a county, state, country, continent, geographical region, or the like. As such, prior to instructing a particular voucher processor 108 to generate and deliver a tangible voucher to a designated recipient 110, the issuer 104 may first determine which of multiple voucher processors 108 is closest, in terms of shortest expected delivery time, to the designated recipient 110 and then instruct the voucher processor 108 that is determined to be closest to the designated recipient 110 to generate and deliver the tangible voucher to the designated recipient 110. In these and other embodiments, delivery of tangible vouchers may involve 3^{rd} party carriers such as the United States Postal Service, UPS, Fed-Ex, or the like.

A distance between the voucher processors 108 and the designated recipient 110 may be one factor, and in some cases the only factor, used to determine which voucher processor 108 is closest in terms of shortest expected delivery time to the designated recipient 110. For instance, an expected delivery time from a first voucher processor 108 less than one-hundred miles from the designated recipient 110 may be shorter than an expected delivery time from a second voucher processor 108 more than one-thousand miles from the designated recipient 110.

Other factors may alternately or additionally be considered in determining which of multiple voucher processors 108 is closest in terms of shortest expected delivery time to the designated recipient 110. By way of example only, local 3^{rd} party carrier routes, local pickup times for the 3^{rd} party carriers, and/or other factors may affect the shortest expected delivery time. For instance, while a first voucher processor 108 may be a few miles closer to the designated recipient 110 than a second voucher processor 108, local 3^{rd} party carrier routes and/or local pickup times for 3^{rd} party carriers may be such that the shortest expected delivery time may be from the second voucher processor 108 rather than from the first voucher processor 108.

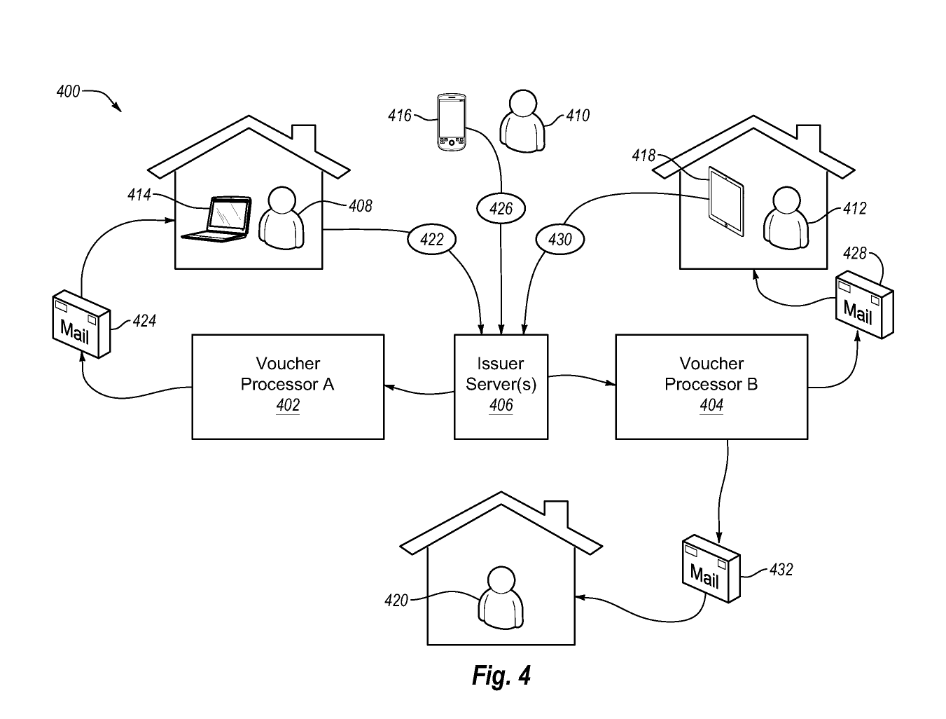

FIG. 4 illustrates an example distributed processing architecture 400 that may be implemented in the operating environment of FIG. 1, arranged in accordance with at least some embodiments described herein. The distributed processing architecture 400 includes multiple voucher processors 402, 404, only two of which are depicted in FIG. 4, and one or more issuer servers 406. Each of the voucher processors 402, 404 may correspond to the voucher processor 108 of FIG. 1, while the issuer server 406 may correspond to one or both of the voucher server 120 and the processing server 124 of FIG. 1.

FIG. 4 additionally illustrates consumers A, B and C 408, 410, 412, associated communication devices 414, 416, 418, and a designated recipient 420. Each of the consumers A, B and C 408, 410, 412 may correspond to the consumer 102 of FIG. 1. Each of the communication devices 414, 416, 418 may correspond to any of the communication devices 114 of FIG. 1, although in the illustrated embodiment of FIG. 1, communication device 414 is depicted as a desktop computer, communication device 416 is depicted as a smartphone, and communication device 418 is depicted as a tablet computer.

Three scenarios are depicted in FIG. 4. In a first example scenario, consumer A 408 operates the communication device 414 to acquire a voucher from the issuer server 406, as denoted at 422. Consumer A 408 may choose to receive the voucher as a tangible voucher. Accordingly, the issuer server 406 may determine that out of the voucher processor A 402 and the voucher processor B 404, voucher processor A is closest to consumer A 408. As such, the issuer server 406 may mark a voucher record in a voucher database (not shown) corresponding to the acquired voucher for physical delivery and instruct the voucher processor A 402 to generate and a tangible voucher 424 to consumer A 408. The voucher processor A 402 generates and mails or otherwise delivers the tangible voucher 424 to consumer A 408. In these and other embodiments, the instructions from the issuer server 406 to the voucher processor A 402 (or other voucher processor) may be pushed by the issuer server 406 to the voucher processor A, or pulled by the voucher processor A from the issuer server 406.

In a second example scenario, consumer B 410 operates the communication device 416 to acquire a voucher from the issuer server 406, as denoted at 426. Consumer B 410 may designate consumer C 412 as the designated recipient to receive the voucher in a tangible form. The issuer server 406 may determine that the voucher processor B 404 is the closest of the voucher processors in the distributed processing architecture 400 and may mark a corresponding voucher record accordingly. The voucher processor B 404 receives instructions from the issuer server 406, generates a corresponding tangible voucher 428, and mails or otherwise delivers the tangible voucher 428 to consumer C 412.

In a third example scenario, consumer C 412 operates the communication device 418 to acquire a voucher from the issuer server 402, as denoted at 430. Consumer C 418 in this example obtains the voucher as a digital voucher. Subsequently, consumer C 418 operates the communication device 418 to convert the digital voucher to a tangible voucher 432 and have the tangible voucher 432 delivered to the designated recipient 420. In particular, consumer C 412 instructs the issuer server 406, via the communication device 418, to convert the digital voucher to the tangible voucher 432, as also denoted at 430. The issuer server 406 then determines that the voucher processor B 404 is the closest of the voucher processors in the distributed processing architecture 400 and marks a corresponding voucher record accordingly. The voucher processor B 404 receives instructions from the issuer server 406, generates the tangible voucher 432, and mails or otherwise delivers the tangible voucher 432 to the designated recipient 420.

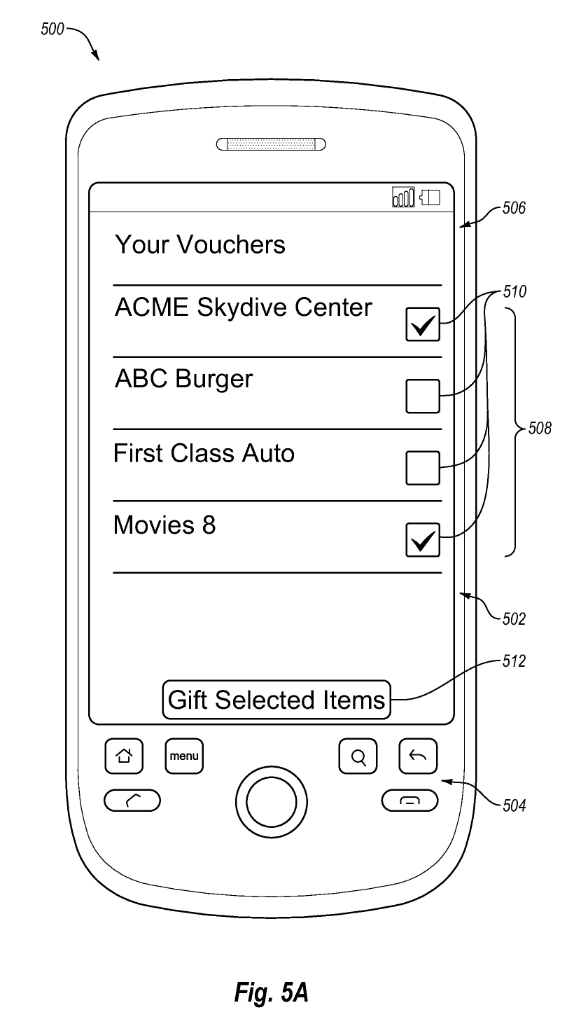

FIGS. 5A-5C illustrate a communication device 500 and aspects of a voucher application (not shown) that may be executed by the communication device 500 to convert digital vouchers to tangible vouchers, arranged in accordance with at least some embodiments described herein. The communication device 500 may be associated with a consumer and may correspond to, e.g., any of the communication devices 114 of FIG. 1. The voucher application executed by the communication device 500 may correspond to the voucher application 116 of FIG. 1.

In the illustrated embodiment, the communication device 500 includes a touchscreen 502 operable to provide both input and output functions and one or more buttons 504 operable to provide input functions. More generally, the communication device 500 may include one or more input devices, such as touchscreen, keyboard, mouse, button, or the like, and one or more output devices, such as a touchscreen, display, speaker, vibrator, or the like.

The voucher application may be executable by the communication device 500 to maintain a voucher vault including records of an associated consumer's vouchers and synchronize the records with an issuer, such as the issuer 104, and to provide a UI navigable by the consumer to purchase vouchers, display receiver vouchers, and/or provide instructions and accept input for converting digital vouchers to tangible vouchers.

The UI may have various dynamic screens or interfaces for display information to the consumer and/or receiving input to the consumer. For example, in FIG. 5A, an example voucher vault interface 506 is depicted. The voucher vault interface 506 may include a listing 508 of one or more vouchers in a voucher vault, or more generally a record of vouchers, stored on the communication device 500. The voucher vault may be updated by the communication device 500 as vouchers are redeemed, acquired, and/or converted to digital vouchers, or the like.

The voucher vault interface 506 may be configured to accept input effective to select one or more of the vouchers in the listing 508 to convert and send to a designated recipient as a tangible voucher. For instance, in the illustrated embodiment, the voucher vault interface 506 includes one or more checkable boxes 510, one each next to a corresponding entry in the listing 508, and a touch-selectable button 512 that may be selected by the consumer to convert and send in a tangible form the voucher(s) corresponding to the checked entries. In FIG. 5A, both the first and last checkable boxes 510 are illustrated as being checked.

In FIG. 5B, an example recipient designation interface 514 is depicted. The recipient designation interface 514 may be configured to accept recipient information, such as a designated recipient, a mailing address for the designated recipient, and optionally a custom message. For instance, text entry fields 516, 518 and 520 may be included in the recipient designation interface 514 in which text or other data identifying the designated recipient, mailing address, and custom message may be entered.

Optionally, a voucher selection listing 522 may be included in the recipient designation interface 514. Each entry in the voucher selection listing 522 of the recipient designation interface 514 may correspond to a different one of the checked entries from the voucher vault interface 506. In some embodiments, the consumer may toggle between the entries in the voucher selection listing 522 to enter a designated recipient, mailing address and/or custom message for each corresponding voucher, which designated recipient, mailing address and/or custom message may or may not be the same for each corresponding voucher. After the recipient information has been entered in the voucher selection listing 522, the consumer may select a touch-selectable “Next” button 524 or equivalent button to advance to a billing interface 526 illustrated in FIG. 5C.

The billing interface 526 may be configured to accept billing information from the consumer so that a corresponding account can be billed any applicable shipping/handling and/or processing fees associated with sending a tangible voucher. For instance, one or more input fields 528, 530, 532, 534 may be included in the billing interface to accept the billing information. The input field 528 may include a drop-down list of various payment type options, such as credit card, debit card, PayPal account, electronic check, or the like.

The other input fields 530, 532, 534 may include text entry fields in which text or other data may be entered in associated with the selected payment type. In the example of a credit card payment type, the input field 530 may include a name text entry field wherein a name on the credit card account may be entered; the input field 532 may include a billing address text entry field wherein a billing address associated with the credit card account may be entered; and the input field 534 may include a card number text entry field wherein an account number associated with the credit card account may be entered.

In some embodiments, the billing interface 526 additionally includes a review pane 536 showing an amount to be charged to the credit card or other account and the name and shipping address of the designated recipient. After entering the billing information in input fields 528, 530, 532, 534, the consumer may select a touch-selectable “Done” button 538 or equivalent button to complete the process, as far as the consumer is concerned, of converting a digital voucher to a tangible voucher.

Accordingly, some embodiments described herein provide a consumer with a convenient way to acquire vouchers in digital form and the ability to present them to a designated recipient at a later time in tangible form without the need to carry around or keep track of a tangible article like or gift certificate, gift card, or the like. Alternately or additionally, delivery of a tangible voucher to a consumer or a designated recipient using a distributed processing architecture such as described with respect to FIG. 4 may be faster than conventional production and delivery of tangible vouchers from a single (or relatively few) location(s). As such, the consumer or designated recipient may be able to purchase and use tangible vouchers within a relatively short time frame from purchase.

Anytime the consumer 102 converts a digital voucher to a physical voucher or effectuates other changes such as acquiring a new voucher or redeeming a voucher, a voucher record in the corresponding communication device 114 and the voucher database 122 may be created and/or updated accordingly by the voucher server 120. All of the communication devices 114 associated with the consumer 102 may synchronize with the voucher server 120 periodically and/or at other times. Thus, activity associated with the vouchers of the consumer 102 may be seen on all communication devices 114 associated with the consumer 102, even though a given activity may have been at least partially effectuated by a given one of the communication devices. Synchronization with the voucher server 120 thereby allows voucher record changes to propagate across any number of associated communication devices 114.

By maintaining voucher records on the communication devices 114, the consumer 102 may be able to access vouchers even when a network connection to the voucher server 120 is unavailable. The communication devices 114 may also synchronize with the voucher server 120 periodically or at other times. The synchronization process may modify records on the communication device 114, the voucher server 120 (or voucher database 122), or both.

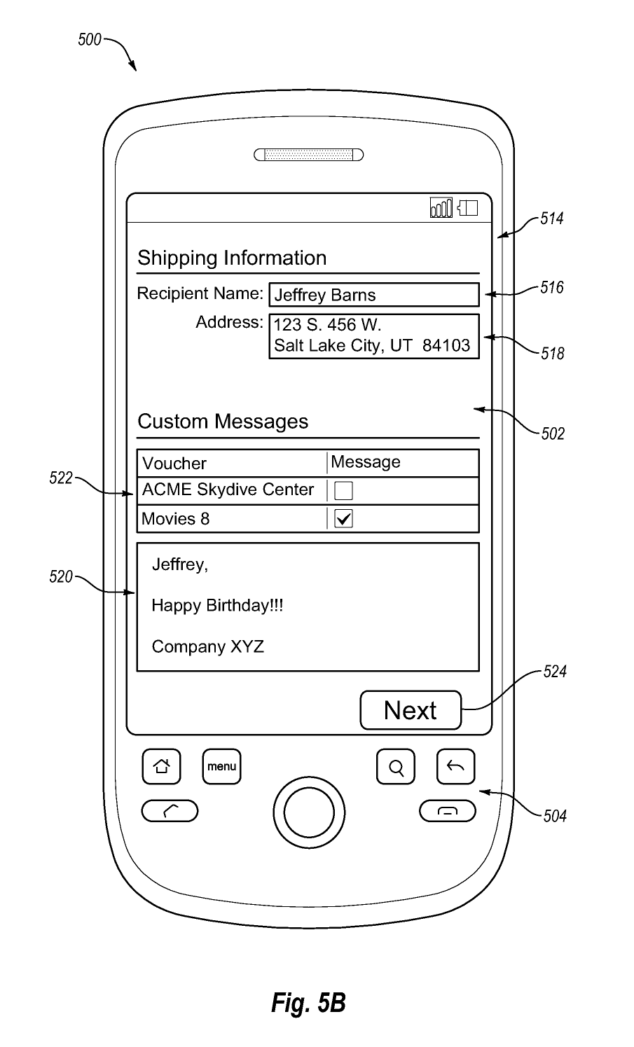

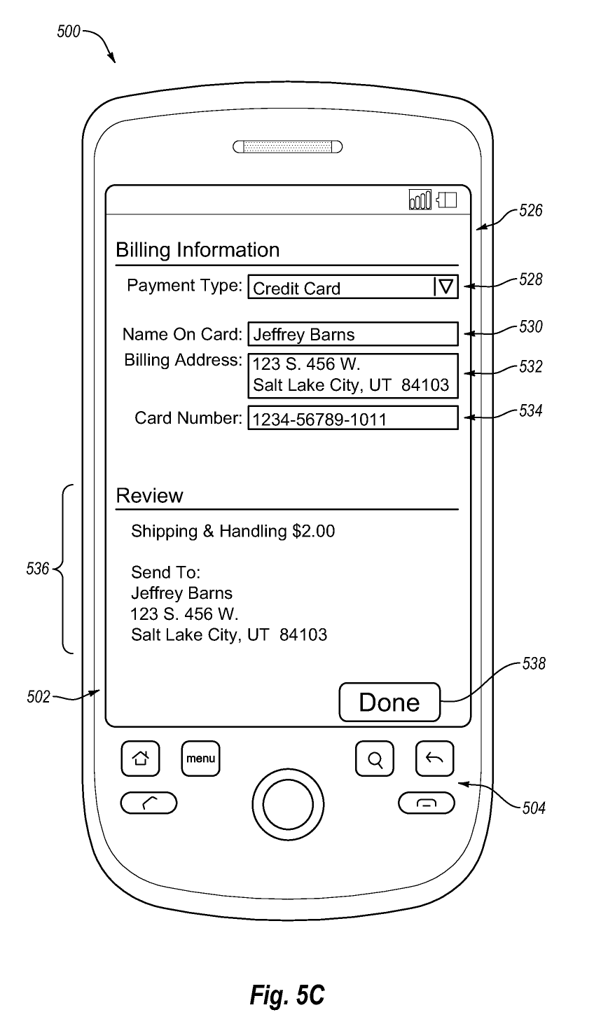

FIG. 6A illustrates a portion 600 of the operating environment 100 of FIG. 1 and an example method of converting a digital voucher to a tangible voucher, arranged in accordance with at least some embodiments described herein. The portion 600 of the operating environment 100 depicted in FIG. 6A may include any one of the communication devices 114A-114C, generically designated at 114, the voucher server 120, the voucher database 122, and one or more of the devices 132, 134, 136 associated with the voucher processor 108, including the voucher printer 132, the label printer 134, and/or the computer 136, generally designated in FIG. 6A as voucher production equipment 132/134/136.

The method of FIG. 6A of converting a digital voucher to a tangible voucher may include accepting various inputs from the consumer 102 associated with the communication device 114, examples of which are described above with respect to FIGS. 5A-5C. The method may also include, at 602, sending a request to convert a digital voucher to a physical voucher from the communication device 114 to the voucher server 120.

At 604, the voucher server 120 modifies a voucher record corresponding to the digital voucher and stored in the voucher database 122 to reflect the change from a digital to a tangible voucher.

At 606, the voucher server 120 formats the voucher record and associated data for the voucher production equipment 132/134/136.

At 608, the voucher server 120 returns an updated voucher record to the communication device 114.

At 610, the voucher server 120 sends the formatted voucher record and associated data to the voucher production equipment 132/134/136.

After receiving the formatted voucher record and associated data, the voucher production equipment 132/134/136 generates a corresponding tangible voucher which can then be mailed or otherwise delivered to a designated recipient.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 6B illustrates a portion 650 of the operating environment 100 of FIG. 1 and another example method of converting a digital voucher to a tangible voucher, arranged in accordance with at least some embodiments described herein. The portion 650 of the operating environment 100 depicted in FIG. 6B may include any one of the communication devices 114A-114C, generically designated at 114, the voucher server 120, the voucher database 122, the processing server 124, and one or more of the devices 132, 134, 136 associated with the voucher processor 108, including the voucher printer 132, the label printer 134, and/or the computer 136, generally designated in FIG. 6B as voucher production equipment 132/134/136.

The method of FIG. 6B of converting a digital voucher to a tangible voucher may include accepting various inputs from the consumer 102 associated with the communication device 114, examples of which are described above with respect to FIGS. 5A-5C. The method may also include, at 652, sending a request to convert a digital voucher to a physical voucher from the communication device 114 to the voucher server 120.

At 654, the voucher server 120 modifies a voucher record corresponding to the digital voucher and stored in the voucher database 122 to reflect the change from a digital to a tangible voucher.

At 656, the voucher server 120 sends the voucher record to the processing server 124.

At 658, the voucher server 120 returns an updated voucher record to the communication device 114.

At 660, the processing server 124 formats the voucher record and associated data for the voucher production equipment 132/134/136.

At 662, the processing server 124 sends the formatted voucher record and associated data to the voucher production equipment 132/134/136.

After receiving the formatted voucher record and associated data, the voucher production equipment 132/134/136 generates a corresponding tangible voucher which can then be mailed or otherwise delivered to a designated recipient.

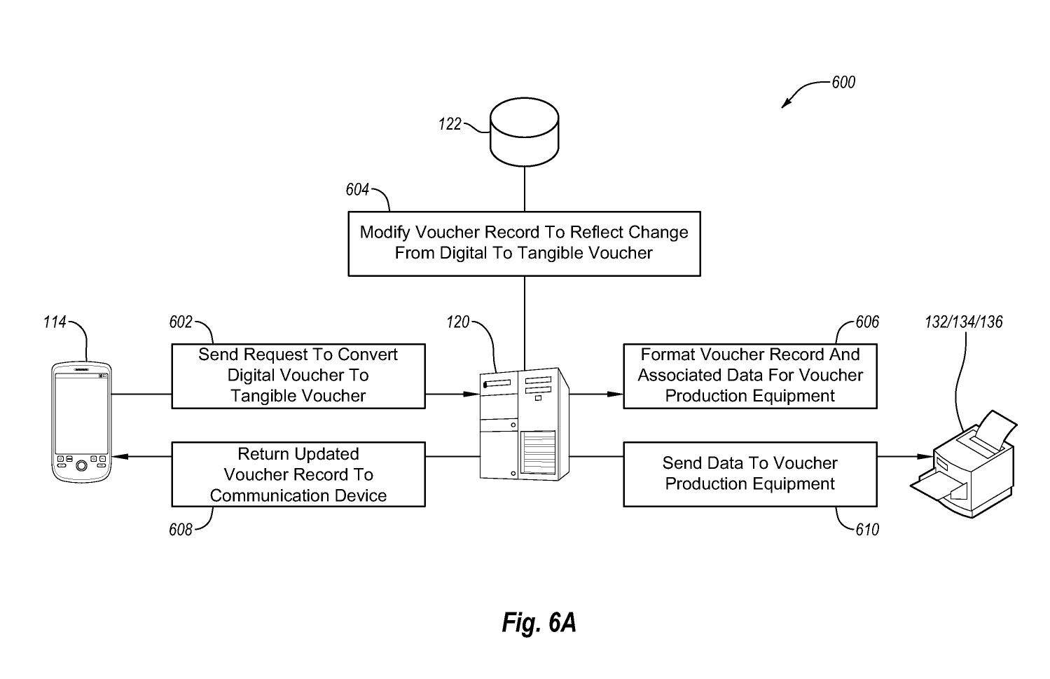

FIG. 7 illustrates an example computing device 700 configured to format voucher records into a format suitable for voucher production equipment, arranged in accordance with at least some embodiments described herein. The computing device 700 may correspond to the voucher server 120 in the example of FIG. 6A, or the processing server 124 in the example of FIG. 6B. The voucher production equipment may correspond to one or more of the voucher printer 132, the label printer 134 or the computer 136 of FIG. 1.

In the illustrated embodiment, the computing device 700 includes a processor 702, a clock 704, a random access memory (RAM) 706, a read only memory 708, and a network interface 710. The random access memory and a memory 712 or other storage device in which one or more voucher records 714 and a print data generator application 716 are loaded. The processor 702 may include, for instance, a central processing unit (CPU), microprocessor, controller, microcontroller, or other suitable processing device.

In operation, the processor 702 is configured to execute computer-executable instructions such as program code in the form of applications or programs that may be stored in ROM 708 and/or loaded into RAM 706 from other storage devices (not shown). Execution of computer-executable instructions by the processor 702 may be clocked according to a clock signal generated by the clock 704. The network interface 710 may be configured to communicate with devices external to the computing device 700, such as the voucher database 122, the production equipment 132, 134, 136 of FIG. 1, and/or other communication devices described herein.

In the illustrated embodiment, one or more voucher records 712, e.g., from the voucher database 122, and a print data generator application 714 are conceptually illustrated as being loaded into RAM 706 or other memory for execution by the processor 702. The print data generator application 714 represents an application or process including computer-executable instructions which, when executed by the processor 702, causes the computing device 700 to perform a processing flow 716 involving various steps and/or operations for converting a digital voucher to a physical voucher.

With combined reference to FIGS. 1 and 7, the processing flow 716 may include retrieving a particular voucher record 718 from the voucher database 122 and converting the particular voucher record 718 (or data therefrom) into an Extensible Markup Language (XML) source document 720. The XML source document 720 and an Extensible Stylesheet Language Transformations (XSLT) stylesheet 722 are passed to an XSLT processor 724. The XSLT stylesheet 722 includes a collection of template rules including instructions and other directives that guide the XSLT processor 724 to produce an output document 726 from the XML source document 720. In the illustrated embodiment, the output document 726 is an Extensible Stylesheet Language (XSL) Formatting Objects (FO), or XSL-FO, document.

XSL-FO is a markup language for XML document formatting which may be used to generate PostScript or PDF files. After the XSL-FO document 726 is generated, it is then passed to an application that may be referred to herein as an FO processor 728. The FO processor 728 is configured to convert the XSL-FO document 726 into an output file 730 that is readable, printable, or both, by the production equipment 132, 134, 136. The output file 730 may include a PDF or PostScript file in some embodiments. The generated output file 730 may then be passed to the network interface 710 which provides the output file 730 to the production equipment 132, 134, 136.

Triggering the computing device 700 to send output file 730 to the production equipment 132, 134, 136 may be automated or initiated manually. In some embodiments, for instance, the voucher processor 108 may operate the computer 136 to access a list of voucher records that have been marked for conversion to tangible vouchers and select the marked voucher records. At that time, the computing device 700 (e.g., either the voucher server 120 or the processing server 124) may format and send the data to the production equipment 132, 134, 136 as described with respect to FIG. 7. Alternately, the computing device 700 may format and send the data to the production equipment 132, 134, 136 automatically as the corresponding voucher records are marked for conversion to tangible vouchers or on a scheduled interval, or the like or any combination thereof.

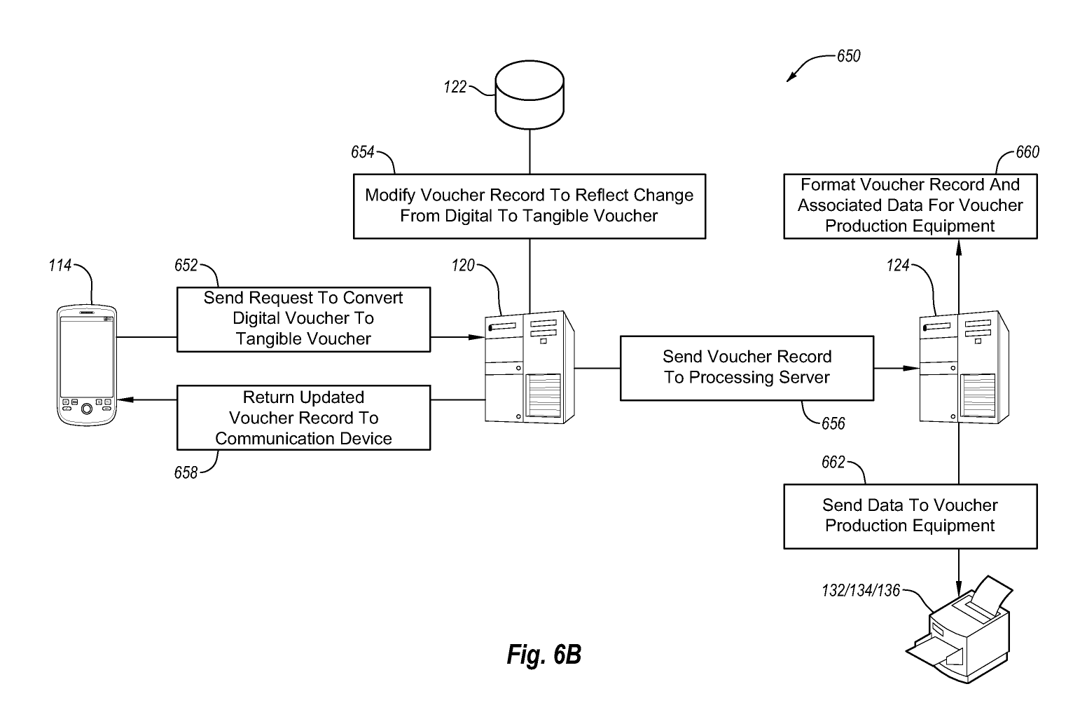

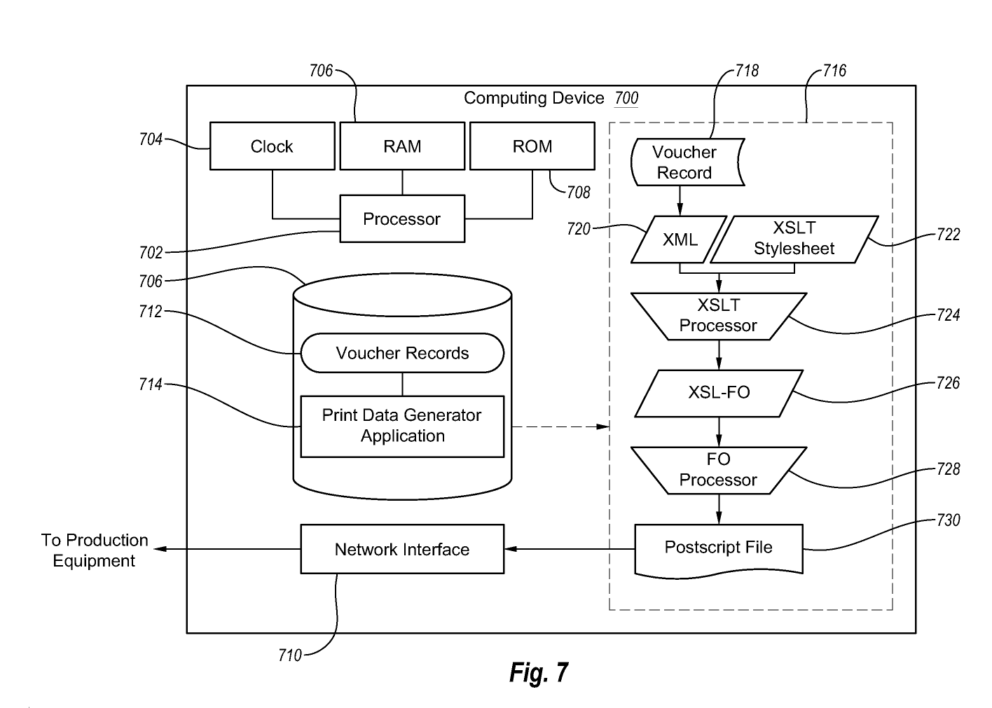

FIG. 8A is a flowchart of an example method 800 of converting a digital voucher to a tangible voucher, arranged in accordance with at least some embodiments described herein. The method 800 may be implemented in whole or in part by, for example, any one of the communication devices 114. For instance, one of the communication devices 114 may execute the voucher application 116 to perform the method 800. The method 800 may include various acts or operations as illustrated by one or more of blocks 802, 804, and/or 806. The method 800 may begin at block 802.

At block 802, data is received indicating successful acquisition of a digital voucher from a voucher server. For example, a consumer may operate a communication device executing a voucher application to acquire a digital voucher from the voucher server. After a desired voucher is identified at the communication device by the consumer, the communication device may send a request to the voucher server for the desired voucher. The voucher server may receive the request, process the request to, for instance, create a voucher record for the desired voucher and associated with the consumer in a voucher database, and send confirmation to the communication device that the desired voucher has been acquired. Block 802 may be followed by block 804.

At block 804, input is received that is effective to select the digital voucher for conversion to a tangible voucher. For instance, the consumer may operate the communication device to select the desired voucher for conversion to a tangible voucher, and to provide designated recipient information and/or billing information as described above with respect to FIGS. 5A-5C. Block 804 may be followed by block 806.

At block 806, data identifying the selected digital voucher and recipient data designating a recipient of the tangible voucher is sent to the voucher server. The recipient data may include, for example, the designated recipient information collected by the recipient designation interface 514 of FIG. 5B.

In these and other embodiments, the voucher server may be configured to coordinate production and delivery of the tangible voucher to the designated recipient as described herein. Coordinating production and delivery of the tangible voucher may include formatting and sending associated data, such as the output file 730 of FIG. 7, to the voucher processor 108 of FIG. 1, or more particularly to the voucher production equipment 132, 134, and/or 136. The associated data may include a name and shipping address of the designated recipient, and/or information from the corresponding voucher record such as one or more of a face value, a unique identifier, and/or the identity of a merchant where the tangible voucher can be redeemed.

Alternately or additionally, coordinating production and delivery of the tangible voucher may include sending associated data, such as the designated recipient information and/or information from the corresponding voucher record to a processing server, such as the processing server 124 of FIG. 1. In these and other embodiments, the processing server may be configured to format the associated data for use by the production equipment of the voucher processor.

Although not illustrated in FIG. 8A, the method 800 may further include, prior to sending the recipient data and data identifying the selected digital voucher to the voucher server, receiving a custom message directed to the designated recipient. For example, the custom message may be received through the text entry field 520 of the recipient designation interface 514 of FIG. 5B.

Alternately or additionally, the method 800 may further include locally storing a record corresponding to the digital voucher prior to sending the recipient data and data identifying the selected digital voucher to the voucher server. An updated record reflecting conversion of the digital voucher to the tangible voucher may be received from the voucher server. The locally stored record may be updated to reflect the conversion.

Some embodiments disclosed herein include a non-transitory computer readable medium having computer-executable instructions stored thereon that are executable by a computing device to perform operations included in the method 800 of FIG. 8A, such as any of the operations illustrated by blocks 802, 804, and/or 806 in FIG. 8A, and/or variations thereof. The non-transitory computer readable medium may be included in, for instance, any one of the communication devices 114 of FIG. 1, and the computer-executable instructions may include, for example, the voucher application 116 of FIG. 1. In these and other embodiments, the communication devices 114 may each include a processor, microprocessor, controller, microcontroller, or other processing device that can execute the computer-executable instructions.

FIG. 8B is a flowchart of another example method 810 of converting a digital voucher to a tangible voucher, arranged in accordance with at least some embodiments described herein. The method 810 may be implemented in whole or in part by, for example, the voucher server 120 of FIG. 1. The method 810 may include various acts or operations as illustrated by one or more of blocks 812, 814, and/or 816. The method 810 may begin at block 812.

At block 812, a request to convert a digital voucher to a tangible voucher is received. The request may be received at a voucher server, such as the voucher server 120, from a communication device, such as any one of the communication devices 114 of FIG. 1. A voucher record corresponding to the digital voucher may be stored on a voucher database, such as the voucher database 122 of FIG. 1, or may be otherwise accessible to the voucher server. Block 812 may be followed by block 814.

At block 814, the voucher record corresponding to the digital voucher is modified to reflect conversion of the digital voucher to the tangible voucher. For instance, the voucher record may be marked as being converted to a tangible voucher, and/or a particular one of multiple voucher processors, such as the voucher processor 108, may be identified to generate the tangible voucher. Block 814 may be followed by block 816.

At block 816, the voucher server coordinates the production and delivery of the tangible voucher to a designated recipient with a voucher processor having production equipment. For example, the voucher processor having production equipment may be the voucher processor identified in the modified voucher record.

In these and other embodiments, coordinating production and delivery of the tangible voucher may include sending associated data to the voucher processor, or more particularly to the production equipment of the voucher processor. The associated data may include a name and shipping address of the designated recipient, and/or information from the corresponding voucher record such as one or more of a face value, a unique identifier, and/or the identity of a merchant where the tangible voucher can be redeemed. Prior to sending the associated data to the voucher processor, the method 810 may additionally include formatting the associated data for use by the production equipment of the voucher processor. For instance, the voucher server may format the associated data into an output file, such as the output file 730 of FIG. 7, as described with respect to FIG. 7.

Alternately or additionally, coordinating production and delivery of the tangible voucher may include sending associated data to a processing server, such as the processing server 124 of FIG. 1. The associated data may include a name and shipping address of the designated recipient, and/or information from the corresponding voucher record such as one or more of a face value, a unique identifier, and/or the identity of a merchant where the tangible voucher can be redeemed. In these and other embodiments, the processing server may be configured to format the associated data for use by the production equipment of the voucher processor. For instance, the processing server may format the associated data into an output file, such as the output file 730 of FIG. 7, as described with respect to FIG. 7.

Although not depicted in FIG. 8B, the method 810 may further include, prior to coordinating production and delivery of the tangible voucher, selecting the voucher processor from multiple available voucher processors. The voucher processors may be included in a distributed network of voucher processors such as illustrated in the distributed processing architecture 400 of FIG. 4. In these and other embodiments, selecting the voucher processor may include determining that a distance between the designated recipient and the selected voucher processor is less than a distance between the designated recipient and any of the other tangible processors.

Some embodiments disclosed herein include a non-transitory computer readable medium having computer-executable instructions stored thereon that are executable by a computing device to perform operations included in the method 810 of FIG. 8B, such as any of the operations illustrated by blocks 812, 814, and/or 816 in FIG. 8B, and/or variations thereof. The non-transitory computer readable medium may be included in, for instance, the voucher server 120 of FIG. 1 or the computing device 700 of FIG. 7, and may be embodied as the RAM 706 of FIG. 7.

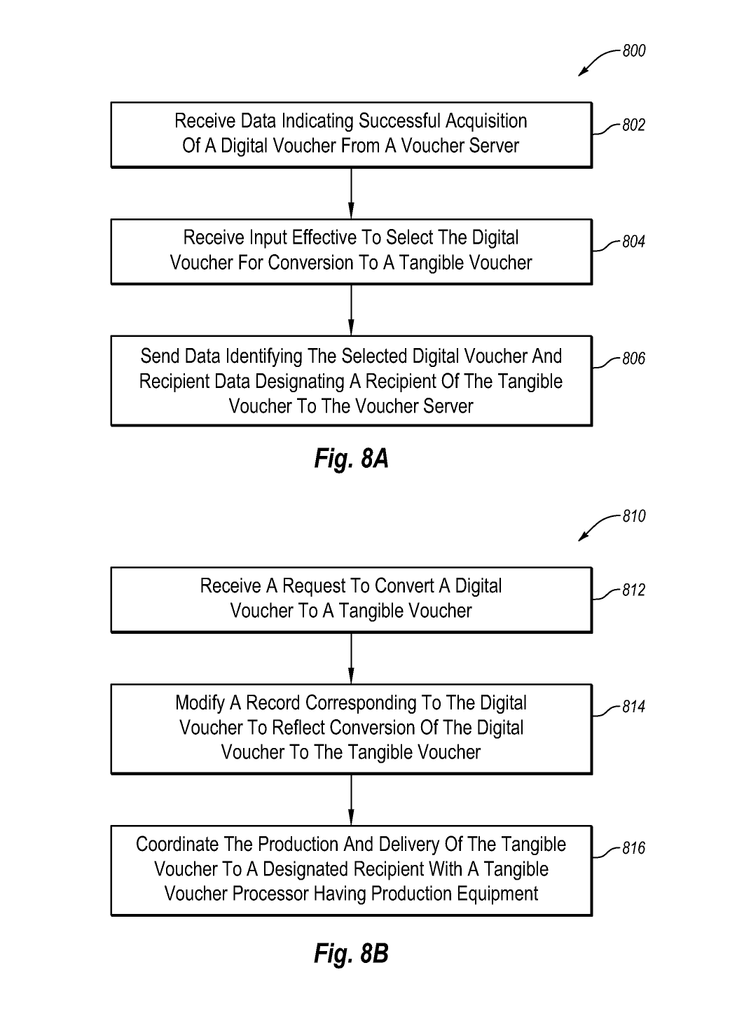

FIG. 9 is a flowchart of an example method 900 of converting a voucher record to a printable format suitable for production equipment, arranged in accordance with at least some embodiments described herein. The method 900 may be implemented in whole or in part by, for example, the voucher server 120 or the processing server 124 of FIG. 1 and/or the computing device 700 of FIG. 7. The method 900 may include various acts or operations as illustrated by one or more of blocks 902, 904, 906, 908, and/or 910. The method 900 may begin at block 902.

At block 902, a voucher record is received that identifies a face value and a unique identifier of a digital voucher purchased by a consumer and selected for conversion to a tangible voucher deliverable to a designated recipient. The designated recipient may be identified by recipient information included with the voucher record. The voucher record may be retrieved directly from a voucher database, such as the voucher database 122 of FIG. 1, or from a voucher server, such as the voucher server 120 of FIG. 1, that retrieves the voucher record from the voucher database. Block 902 may be followed by block 904.

At block 904, the voucher record is converted to a markup language document, such as the XML source document 720 of FIG. 7. Block 904 may be followed by block 906.

At block 906, a collection of template rules is applied to the markup language document to generate a formatted markup language document. The collection of template rules may be embodiment as an XSLT stylesheet, such as the XSLT stylesheet 722 of FIG. 7. The formatted markup language document may include, for instance, the XSL-FO document 726 of FIG. 7. Block 906 may be followed by block 908.

At block 908, the formatted markup language document is converted to an output document that is at least one of readable or printable. The output document may include, for example, the output file 730 of FIG. 7. Alternately or additionally, the output document may include a PDF or PostScript file, both of which are examples of files that may be readable and/or printable. Block 908 may be followed by block 910.

At block 910, the output document is sent over a network to production equipment configured to generate the tangible voucher from the output document. For example, the output document may be sent over the network by the network interface 710 of FIG. 7 to the production equipment 132, 134, 136 of FIG. 1.

Some embodiments disclosed herein include a non-transitory computer readable medium having computer-executable instructions stored thereon that are executable by a computing device to perform operations included in the method 900 of FIG. 9, such as any of the operations illustrated by blocks 902, 904, 906, 908, and/or 910 in FIG. 9, and/or variations thereof. The non-transitory computer readable medium may be included in, for instance, the voucher server 120 or processing server 124 of FIG. 1 as embodied by the computing device 700 of FIG. 7, and/or the non-transitory computer readable medium may be embodied as the RAM 706 of FIG. 7.

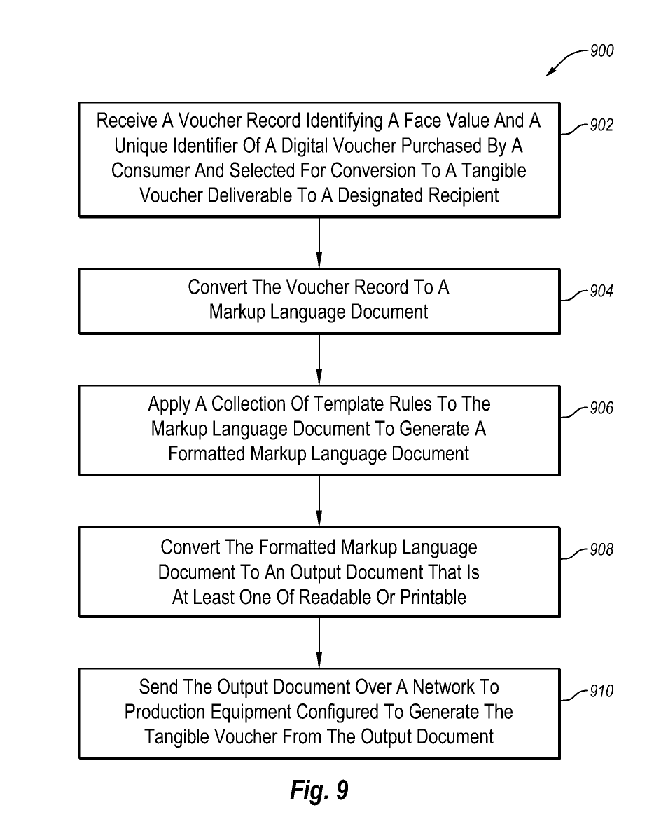

FIG. 10 illustrates an example of a voucher database 1000 that may be implemented in the operating environment 100 of FIG. 1, arranged in accordance with at least some embodiments described herein. The voucher database 1000 may correspond to the voucher database 122 of FIG. 1.

The voucher database 1000 may include one or more tables, such as a user table, a voucher table, and/or an order table. The user table may include one or more entries, each corresponding to a different consumer or user. For each entry, the user table may include one or more fields such as a userId field, a firstName field, a lastName field, a username field, a password field, and/or an email address field. The userId field may include a unique identifier assigned by the voucher database 1000 or a voucher server, or the like, that identifies the corresponding consumer and may be used in the other tables to relationally associate the corresponding consumer with a given voucher and/or order. The firstName and lastName fields may include identifying information previously provided by the consumer, such as the consumer's first name and last name. The username and password fields may include login credentials, such as a username and password, that may be used by the corresponding consumer to login into an account of the consumer to access information about, e.g., vouchers acquired by the consumer. The emailAddress field may include an email address of the consumer that can be used to provide email notifications or other information to the consumer. Although not shown, the user table may alternately or additionally include one or more other fields for each entry including billing information, shipping information, and/or other information.

The order table may include one or more entries, each corresponding to a different order for one or more vouchers (“voucher order”). For each entry, the order table may include an orderId field, a userId field, a merchantId field, an orderTotal field, and an orderDate field. The orderId field may include a unique identifier assigned by the voucher database 1000 or the voucher server, or the like, that identifies the corresponding voucher order and may be used in one or more other tables to relationally associate the corresponding voucher order with a given user and/or voucher. The userId field includes the unique identifier assigned to the corresponding consumer that placed the voucher order. The merchantId field includes a unique identifier assigned to a merchant where the corresponding voucher may be redeemed. The orderTotal field includes a cost of the corresponding voucher order. The orderDate field may include a timestamp indicating a date and/or time date at which the corresponding voucher order was placed.

The voucher table may include one or more entries or voucher records as described above, each corresponding to a different voucher. For each entry, the voucher table may include one or more fields, such as a voucherId field, an orderId field, a uniqueId field, a valid field, an openedAtLocationId field, an openedOn field, a type field, and a voucher processor field. The voucherId field may include a unique identifier assigned by the voucher database 1000 or the voucher server, or the like, that identifies the corresponding voucher. The orderID field includes the unique identifier assigned to the corresponding voucher order. Thus, each voucher may be associated with a corresponding consumer through the orderId in the voucher table that essentially points to a particular voucher order in the order table, and through the userId field in the order table that essentially points to a particular consumer in the consumer table.

With continued reference to the voucher table, the uniqueId field may include a unique identifier such as a serial number and/or other data representing a serial number or barcode of the voucher. The valid field may be a binary field (e.g., either 1 or 0) to designate whether the corresponding voucher is valid or not valid.

The openedAtLocationId field may include an identifier corresponding to a particular location at which the corresponding voucher was presented as a digital voucher on a communication device to a merchant. The openedOn field may include a timestamp indicating a date and/or time at which the corresponding voucher was presented at the particular location identified in the openedAtLocationId field. The openedAtLocationId field and the openedOn field may be set to null in circumstances where these fields are inapplicable, such as where the corresponding voucher has been converted to a tangible voucher. Information in the openedAtLocationId field and the openedOn field may be used in various methods for redeeming digital vouchers as described in greater detail below.

The type field may be a binary field (e.g., either 1 or 0) to designate whether the corresponding voucher is a digital voucher (0) or has been converted to a tangible voucher (1). This field may be updated from 0 to 1 by, e.g., the voucher server, after receiving instructions from a communication device to convert a digital voucher to a tangible voucher as explained above. The voucher processor field may include a unique identifier that identifies a particular voucher processor from among multiple processors determined to be the closest to a designated recipient of a tangible voucher. The voucher processor field may be set to null where the corresponding voucher is a digital voucher.

Although not depicted in FIG. 10, the voucher table or other table in the voucher database 1000 may also include, for each entry, one or more fields for a face value, merchant location(s), expiration date, limitations, or other information associated with the corresponding voucher that may be displayed on a corresponding digital voucher and/or printed on a corresponding tangible voucher.

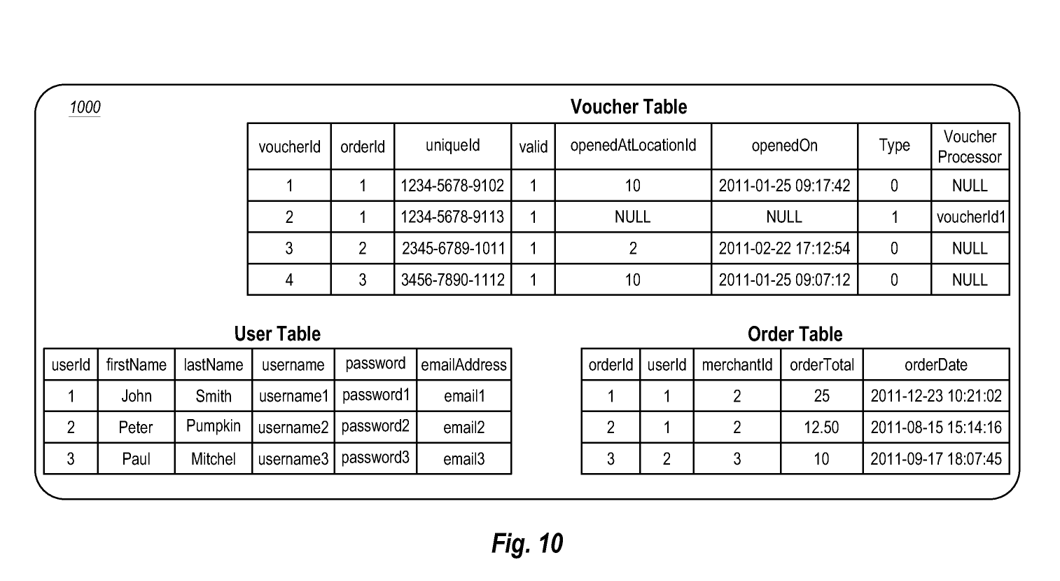

FIG. 11 illustrates an example of a voucher redemption UI 1100 that may be associated with the redemption application 130 executed by the merchant's 106 computer 128 of FIG. 1, arranged in accordance with at least some embodiments described herein. In particular, the redemption application 130 may be executed by the computer 128 or other computing device to provide the voucher redemption UI 1100 which may be navigable by the merchant 106 to redeem digital vouchers presented to the merchant 106.

In operation, and with combined reference to FIGS. 1 and 10-11, the consumer 102 presents a digital voucher to the merchant 106 on one of the consumer's 102 communication devices 114, such as the communication device 116. The merchant 106 may scan the presented digital voucher, or more particularly, a barcode of the digital voucher, with the scanner 126 to enter the digital voucher's barcode into the computer 128. More generally, the merchant 106 may enter any unique identifier of the digital voucher into the computer 128 using any suitable device or method.

The communication device 114C may also send, to the voucher server 120, location data identifying a location of the communication device 114C at the time the digital voucher is presented to the merchant 106, and/or a timestamp. The communication device 114C may determine and send the location data to the voucher server 120 in response to, e.g., the consumer 102 operating the communication device 114C to display the digital voucher, in response to the merchant 106 entering a merchant-specific operating mode of the voucher application 116 on the communication device 114C, or in response to other triggers such as some predetermined input from the consumer 102 and/or the merchant 106.

The location of the communication device 114C may be determined using Global Positioning System (GPS), Global System for Mobile Communications (GSM) localization, multilateration (also known as hyperbolic positioning and based on calculating time difference of arrival (TDOA)), Enhanced Observed Time Difference (E-OTD), or any other suitable technology for determining a geographic location of the communication device 114C.

The voucher server 120 may determine, based on the location data, whether the communication device 114C is at a valid location, e.g., a known location at which the digital voucher may be redeemed. The known locations may be digital voucher-specific. For instance, the known locations associated with one digital voucher may be different than the known locations associated with a different digital voucher. Additionally, the known locations may correspond to known business locations of the merchant 106 or other locations associated with the merchant 106 where the digital voucher may be redeemed. Moreover, the known locations may be identified in the voucher database 122 by the identifiers depicted in the openedAtLocationId field of FIG. 10 in some embodiments.

In some embodiments, the voucher server 120 determines whether the communication device 114C is at a valid location by calculating a distance between the location of the communication device 114C identified by the location data received from the communication device 114C and one or more known locations at which the digital voucher may be redeemed. If the distance between the location of the communication device 114C and any of the known locations is less than a predetermined distance, it may be determined that the communication device 114C is at a valid location.

After determining that the communication device 114C is at a known location, the voucher server 120 may update a corresponding voucher record in, e.g., the voucher table of FIG. 10, to include an identifier of the corresponding known location in the openedAtLocationId field and a timestamp in the openedOn field of the corresponding voucher record in the voucher table. Alternately, if it is determined that the communication device 114C is not at a valid location, the voucher server 120 may not update the corresponding voucher record.

The merchant 106 can then access the redemption application 130 on the computer 128 to request, receive and display voucher records 1102 in a voucher redemption UI such as the voucher redemption UI 1100 of FIG. 11. Whereas numerous vouchers redeemable by the merchant 106 may have been issued consumers 102, the voucher redemption UI 1100 may include numerous voucher records. To simplify the process of selecting and marking voucher records corresponding to presented digital vouchers, the voucher records may be filtered and/or sorted according to various criteria, such as by location and/or time at which the digital vouchers were presented at the location. For instance, the voucher records may be filtered such that only voucher records corresponding to digital vouchers at a particular known location are displayed in the list of voucher records 1102 and/or the voucher records may be sorted such that the voucher records corresponding to digital vouchers presented at the particular known location are presented at the top (or bottom) of the list of voucher records 1102. Alternately or additionally, the voucher records may be sorted in chronological (or reverse chronological) order according to the time at which the corresponding digital vouchers were presented at the known location.

The information in the openedAtLocationId field and/or the openedOn field in the voucher table of FIG. 10 may be used to sort the voucher records. Moreover, the voucher records may be sorted by the voucher server 120 prior to sending the voucher records to the redemption application 130, or the voucher records may be sorted by the redemption application 130 after receiving unsorted voucher records, or differently sorted voucher records, from the voucher server 120.

While the voucher records 1102 are displayed in the voucher redemption UI 1100, the merchant 106 may review and select voucher records corresponding to vouchers that have been presented to the merchant 106 for redemption by checking a corresponding checkable box 1104. The merchant 106 in some cases may manually compare a list (not shown) of vouchers presented for redemption to the merchant 106 with the voucher records 1102 in the voucher redemption UI 1100. The list may be generated by the scanner 106 and stored in the computer 128 in some embodiments. The voucher record 1102 of any voucher presented for redemption to the merchant 106 may then be checked, and a “Mark as Redeemed” button 1106 or button with equivalent functionality may be selected to mark the checked voucher records as redeemed. Alternately or additionally, the comparison of the list of vouchers presented for redemption to the merchant 106 with the voucher records 1102 in the voucher redemption UI 1100 may be performed automatically by the computer 128 or other computing device. The computer 128 may then send the voucher server 120 a list of voucher records marked as redeemed to update the voucher database 122 accordingly.

In other embodiments, the voucher application 116 on the communication device 114C may be used to mark a presented digital voucher as redeemed. In these and other embodiments, the consumer 102 presents the digital voucher to the merchant 106 on the communication device 114C executing the voucher application 116. The merchant 106 can then operate the communication device 114C executing the voucher application 116 to access a merchant-specific operating mode of the voucher application 116 by entering a username, password, in number, or other merchant login credentials. The merchant 106 may preliminarily mark the digital voucher as redeemed and the communication device 114C may send location data along with voucher data identifying the digital voucher and/or indicating it has been marked as redeemed to the voucher server 120. The voucher server 120 may determine whether the communication device 114C is at a valid location based on the location data received from the communication device 114C and provide a response to the communication device 114C indicating whether the communication device 114C is at a valid location. If so, the voucher record in the voucher database 122 and in the communication device 114C may be permanently marked as redeemed, if not, the voucher record in the voucher database 122 and in the communication device 114C may not be marked as redeemed and the communication device 114C may display an error message.

In some embodiments, the scanner 126 or other device used to enter a barcode or other unique identifier of the digital voucher may send location data identifying a location of the scanner 126 or other device to the voucher server 120. The location of the scanner 126 may approximate a location of the communication device 114C on which the digital voucher is displayed based on a proximity required for scanning or otherwise entering the barcode or other unique identifier of the digital voucher. The voucher server 120 may then determine if the digital voucher is being presented at a valid location as already described above before updating a corresponding voucher record in the voucher database 122. The scanner 126 or other device may then display a redemption status, such as “successful” or “unsuccessful.” The voucher application 116 executing on the communication device 114C may subsequently synchronize with the voucher server 120 to remove or update any records stored on the communication device 114C consistent with the updates made in response to communications between the scanner 126 or other device and the voucher server 120.

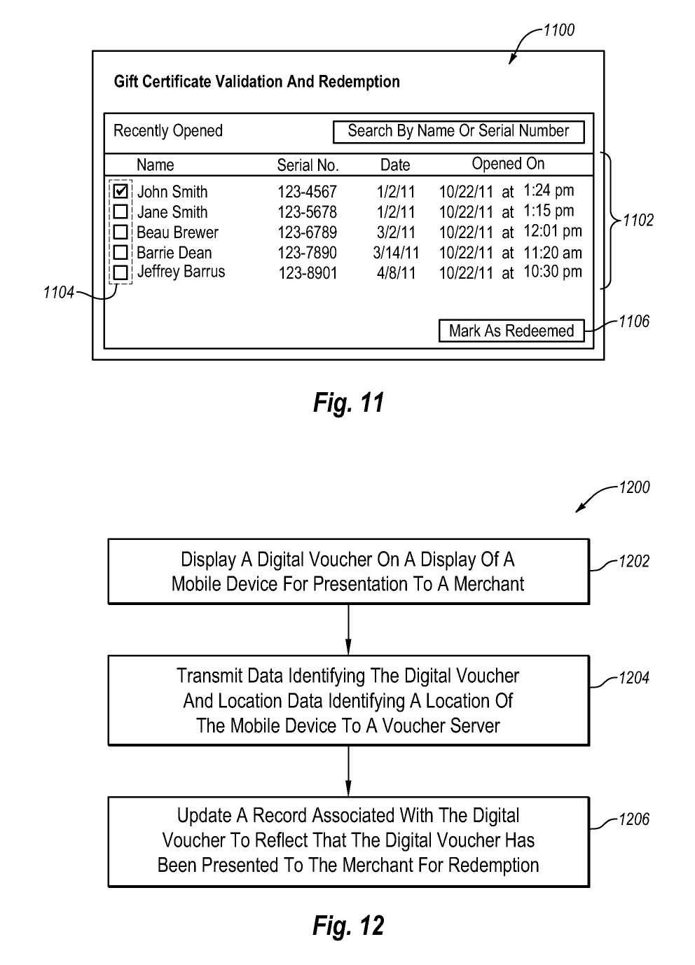

FIG. 12 is a flowchart of an example method 1200 of redeeming digital vouchers, arranged in accordance with at least some embodiments described herein. The method 1200 may be implemented in whole or in part by, for example, a mobile device such as the communication devices 114A and 114C of FIG. 1. For instance, either of the communication devices 114A, 114C may execute the voucher application 116 to perform the method 1200. The method 1200 may include various acts or operations as illustrated by one or more of blocks 1202, 1204, and/or 1206. The method 1200 may begin at block 1202.

At block 1202, a digital voucher is displayed on a display of a mobile device for presentation to a merchant. Block 1202 may be followed by block 1204.

At block 1204, data identifying the digital voucher and location data identifying a location of the mobile device is transmitted to a voucher server. Block 1204 may be followed by block 1206.

At block 1206, a record on the mobile device associated with the digital voucher may be updated to reflect that the digital voucher has been presented to the merchant for redemption.

Although not illustrated in FIG. 12, the method 1200 may further include receiving input effective to select the digital voucher for display. For instance, the voucher application 116 executing on the communication device 114A, 114C may provide a UI navigable by the consumer 102 to view a list of digital vouchers and to select one of the digital vouchers for display on the communication device 114A, 114C, an example of which is illustrated in FIG. 2.

Alternately or additionally, the method 1200 may further include, prior to transmitting the location data identifying a location of the mobile device to the voucher server, determining the location of the mobile device. Determining a location of the mobile device may include determining the location of the mobile device using one or more of GPS, GSM localization, multilateration, E-OTD, or NLBS.

The method 1200 in some embodiments may further include receiving input at the mobile device from the merchant effective to preliminarily mark the digital voucher as redeemed. Prior to receiving the input from the merchant, the method may further include receiving one or more credentials from the merchant effective to access an application state on the mobile device that is only accessible by merchants. The credentials may include at least one of a username, a password, a personal identification number (PIN), or the like.

The voucher server may determine based on the location data, whether the mobile device is at a valid location. If so, the method 1200 may further include the mobile device receiving a message from the voucher server indicating that the mobile device is at a valid location. In these and other embodiments, the record on the mobile device associated with the digital voucher and updated as described with respect to block 1206 may be updated in response to receiving the message. If the voucher server determines that the mobile device is not at a valid location, the method 1200 may further include the mobile device receiving a message from the voucher server indicating that the mobile device is not at a valid location. The mobile device may then display an error message indicating that the mobile device is not at a valid location.

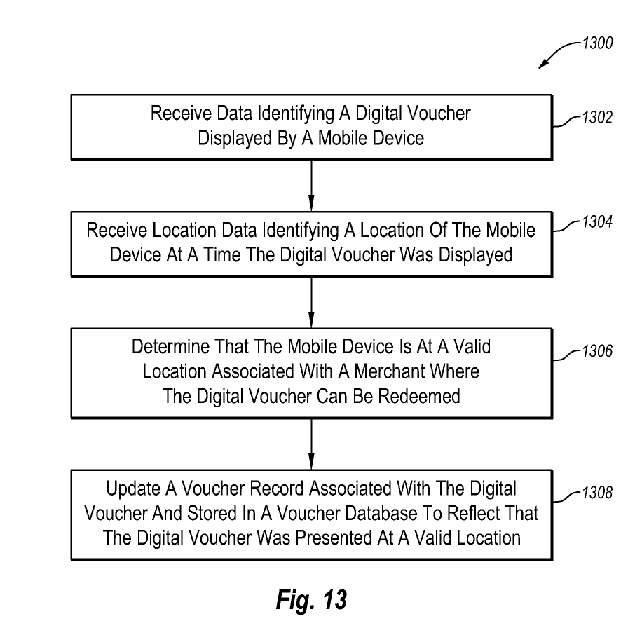

FIG. 13 is a flowchart of an example method 1300 of redeeming digital vouchers, arranged in accordance with at least some embodiments described herein. The method 1300 may be implemented in whole or in part by, for example, a voucher server such as the voucher server 120 of FIG. 1. The method 1300 may include various acts or operations as illustrated by one or more of blocks 1302, 1304, 1306, and/or 1308. The method 1300 may begin at block 1302.

At block 1302, data is received identifying a digital voucher displayed by a mobile device. The digital voucher may be displayed by the mobile device for presentation to a and redemption by a merchant in some embodiments. Block 1302 may be followed by block 1304.

At block 1304, location data is received identifying a location of the mobile device at a time the digital voucher was displayed. Block 1304 may be followed by block 1306.

At block 1306, it is determined that the mobile device is at a valid location associated with the merchant where the digital voucher can be redeemed. The determination may be based on the location data. Determining, based on the location data, that the mobile device is at a valid location may include calculating a distance between the location of the mobile device identified by the location data and a known location associated with the merchant and determining that the calculated distance is within a predetermined distance from the known location. Block 1306 may be followed by block 1308.

At block 1308, a voucher record associated with the digital voucher and stored in a voucher database is updated to reflect that the digital voucher was presented at a valid location.

Although not shown in FIG. 13, the method 1300 may further include receiving a request from a redemption application executed by a computing device associated with the merchant for a list of voucher records. The method 1300 may further include sending the list of voucher records to the redemption application.

The list may be sent to the redemption application as a sorted and/or filtered list. Alternately or additionally, the redemption application may sort and/or filter the list. The list may be sorted and/or filtered according to a location identified in each of at least some of the voucher records indicating a location at which corresponding digital vouchers were presented for redemption and/or according to a timestamp identified in each of at least some of the voucher records indicating a time at which corresponding digital vouchers were presented for redemption. The merchant may then review and mark as redeemed voucher records in the list corresponding to digital vouchers presented to the merchant for redemption and return an updated list to the voucher server.

In these and other embodiments, the method 1300 may further include receiving, from the redemption application, confirmation that one or more digital vouchers associated with one or more voucher records in the list were presented to the merchant for redemption. The confirmation received from the redemption application may include the updated list received from the merchant and described in the preceding paragraph. The method 1300 may further include updating the corresponding voucher records to reflect that the corresponding digital vouchers were confirmed as redeemed by the merchant.

In other embodiments, the method 1300 may further include receiving, from the mobile device, input entered into the mobile device by the merchant and effective to preliminarily mark the digital voucher as redeemed. The method 1300 may further include further updating the voucher record associated with the digital voucher to reflect that the digital voucher was confirmed as redeemed by the merchant.

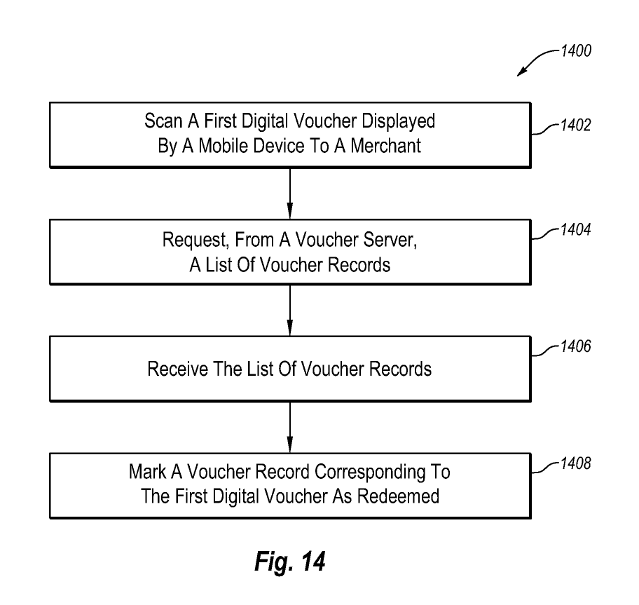

FIG. 14 is a flowchart of an example method 1400 of redeeming digital vouchers, arranged in accordance with at least some embodiments described herein. The method 1400 may be implemented in whole or in part by, for example, a merchant such as the merchant 106 of FIG. 1, including one or more of the scanner 126 and the computer 128. The method 1400 may include various acts or operations as illustrated by one or more of blocks 1402, 1404, 1406, and/or 1408. The method 1400 may begin at block 1402.

At block 1402, a first digital voucher displayed by a mobile device to a merchant is scanned. Block 1402 may be followed by block 1404.

At block 1404, a list of voucher records is requested from a voucher server. The list may include voucher records corresponding to digital vouchers presented for redemption at a location associated with the merchant. Block 1404 may be followed by block 1406.

At block 1406, the list of voucher records is received. The list may be sorted and/or filtered according to a location identified in each of at least some of the voucher records indicating a location at which corresponding digital vouchers were presented for redemption and/or according to a timestamp identified in each of at least some of the voucher records indicating a time at which corresponding digital vouchers were presented for redemption. The list may be sorted and/or filtered by the merchant's computer and/or by the voucher server prior to being received. Block 1406 may be followed by block

At block 1408, a voucher record corresponding to the first digital voucher may be marked as redeemed.

Although not shown, the method 1400 may further include returning an updated list to the voucher server.

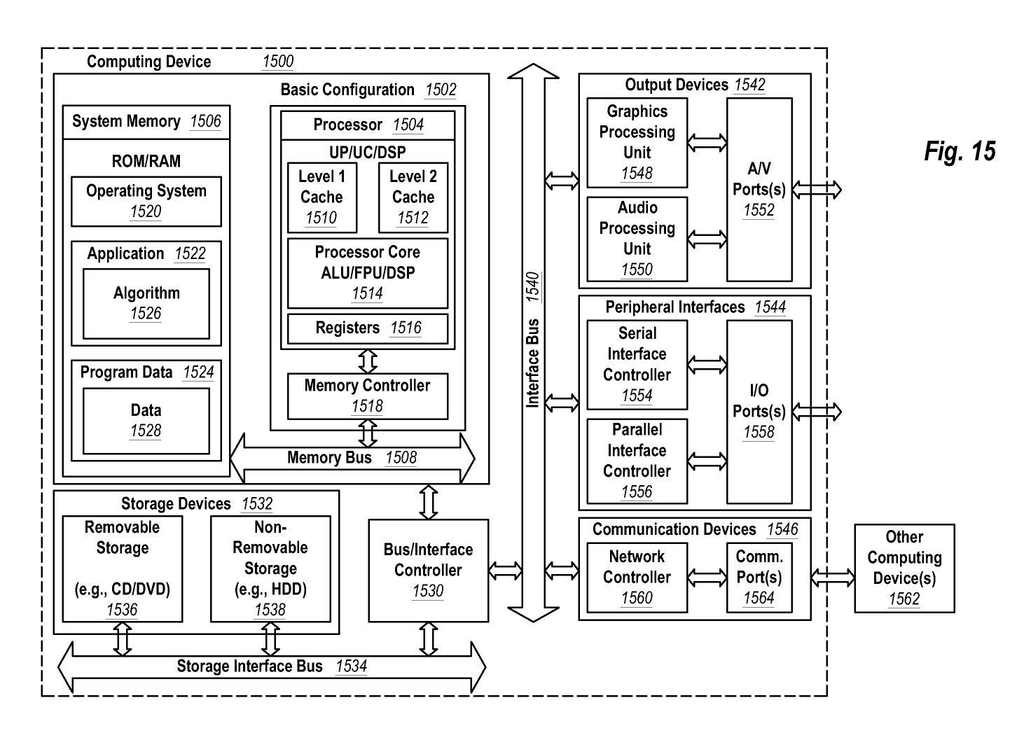

FIG. 15 is a block diagram illustrating an example computing device 1500 that is arranged for converting digital vouchers to tangible vouchers and/or redeeming digital vouchers, arranged in accordance with at least some embodiments described herein. The computing device 1500 may correspond to, for instance, any one of the communication devices 114, the web server 118, the voucher server 120, the voucher database 122, the processing server 124, the scanner 126, the computer 128, the voucher printer 132, the label printer 134, and/or the computer 136. In a very basic configuration 1502, computing device 1500 typically includes one or more processors 1504 and a system memory 1506. A memory bus 1508 may be used for communicating between processor 1504 and system memory 1506.

Depending on the desired configuration, processor 1504 may be of any type including but not limited to a microprocessor (μP), a microcontroller (μC), a digital signal processor (DSP), or any combination thereof. Processor 1504 may include one more levels of caching, such as a level one cache 1510 and a level two cache 1512, a processor core 1514, and registers 1516. An example processor core 1514 may include an arithmetic logic unit (ALU), a floating point unit (FPU), a digital signal processing core (DSP Core), or any combination thereof. An example memory controller 1518 may also be used with processor 1504, or in some implementations memory controller 1518 may be an internal part of processor 1504.

Depending on the desired configuration, system memory 1506 may be of any type including but not limited to volatile memory (such as RAM), non-volatile memory (such as ROM, flash memory, etc.) or any combination thereof. System memory 1506 may include an operating system 1520, one or more applications 1522, and program data 1524. Application 1522 may include a UI algorithm, a voucher algorithm, a redemption algorithm, and/or a server algorithm 1526, generally denoted as “algorithm” in FIG. 15. The algorithm 1526 may be arranged to perform one or more of the functions as described herein including those described with respect to the process 716 of FIG. 7 and/or the methods 800, 810, 900, 1200, 1300, and/or 1400 of FIGS. 8A, 8B, 9, 12, 13, and/or 14. Program data 1524 may include data 1528 such as a voucher records, location data, or the like that may be useful for configuring the algorithm 1526 as is described herein. In some embodiments, application 1522 may be arranged to operate with program data 1524 on operating system 1520 such that digital vouchers may be redeemed and/or converted to tangible vouchers as described herein.

Computing device 1500 may have additional features or functionality, and additional interfaces to facilitate communications between basic configuration 1502 and any required devices and interfaces. For example, a bus/interface controller 1530 may be used to facilitate communications between basic configuration 1502 and one or more data storage devices 1532 via a storage interface bus 1534. Data storage devices 1532 may be removable storage devices 1536, non-removable storage devices 1538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1506, removable storage devices 1536 and non-removable storage devices 1538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1500. Any such computer storage media may be part of computing device 1500.

Computing device 1500 may also include an interface bus 1540 for facilitating communication from various interface devices (e.g., output devices 1542, peripheral interfaces 1544, and communication devices 1546) to basic configuration 1502 via bus/interface controller 1530. Example output devices 1542 include a graphics processing unit 1548 and an audio processing unit 1550, which may be configured to communicate to various external devices such as a display or speakers via one or more A/V ports 1552. Example peripheral interfaces 1544 include a serial interface controller 1554 or a parallel interface controller 1556, which may be configured to communicate with external devices such as input devices (e.g., keyboard, mouse, pen, voice input device, touch input device, etc.) or other peripheral devices (e.g., printer, scanner, etc.) via one or more I/O ports 1558. An example communication device 1546 includes a network controller 1560, which may be arranged to facilitate communications with one or more other computing devices 1562 over a network communication link via one or more communication ports 1564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1500 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method of converting a digital voucher to a tangible voucher, the method comprising:
receiving data indicating successful acquisition of a digital voucher from a voucher server;
receiving input effective to select the digital voucher for conversion to a tangible voucher; and
sending data identifying the selected digital voucher and recipient data designating a recipient of the tangible voucher to the voucher server;
wherein the voucher server is configured to coordinate production and delivery of the tangible voucher to the designated recipient.

2. The method of claim 1, further comprising, prior to sending the recipient data and data identifying the selected digital voucher to the voucher server, receiving a custom message directed to the designated recipient.

3. The method of claim 1, further comprising:
locally storing a record corresponding to the digital voucher prior to sending the recipient data and data identifying the selected digital voucher to the voucher server;
receiving, from the voucher server, an updated record reflecting conversion of the digital voucher to the tangible voucher; and
updating the locally stored record to reflect the conversion.

4. A non-transitory computer readable medium having computer-executable instructions stored thereon that are executable by a computing device to perform the method of claim 1.

5. A method of converting a digital voucher to a tangible voucher, the method comprising:
receiving, from a client application, a request to convert a digital voucher to a tangible voucher, the request designating a recipient;
modifying a record corresponding to the digital voucher to reflect conversion of the digital voucher to the tangible voucher; and
coordinating production and delivery of the tangible voucher to the designated recipient with a tangible voucher processor having production equipment.

6. The method of claim 5, wherein coordinating production and delivery of the tangible voucher with the tangible voucher processor includes sending associated data to the tangible voucher processor, the associated data including a name and shipping address of the designated recipient, a face value of the tangible voucher, a unique identifier of the tangible voucher, and an identity of a merchant where the tangible voucher may be redeemed.

7. The method of claim 6, further comprising, prior to sending the associated data to the tangible voucher processor, formatting the associated data for use by the production equipment of the tangible voucher processor.

8. The method of claim 5, wherein coordinating production and delivery of the tangible voucher with the tangible voucher processor includes sending associated data to a processing server, wherein:
the associated data includes a name and shipping address of the designated recipient, and a face value of the tangible voucher, a unique identifier of the tangible voucher, and an identity of a merchant where the tangible voucher may be redeemed; and
the processing server is configured to format the associated data for use by the production equipment of the tangible voucher processor.

9. The method of claim 5, further comprising, prior to coordinating production and delivery of the tangible voucher with the tangible voucher processor, selecting the tangible voucher processor from a plurality of available tangible voucher processors.

10. The method of claim 9, wherein the plurality of tangible voucher processors are included in a distributed network of tangible voucher processors and wherein selecting the tangible voucher processor includes determining that a distance between the designated recipient and the selected tangible voucher processor is less than a distance between the designated recipient and any of the other tangible voucher processors.

11. A non-transitory computer readable medium having computer-executable instructions stored thereon that are executable by a computing device to perform the method of claim 5.

12. A method of converting a voucher record to a printable format suitable for production equipment, the method comprising:
receiving a voucher record identifying a face value and a unique identifier of a digital voucher purchased by a consumer and selected for conversion to a tangible voucher deliverable to a designated recipient;
converting the voucher record to a markup language document;
applying a collection of template rules to the markup language document to generate a formatted markup language document;
converting the formatted markup language document to an output document that is at least one of readable or printable; and
sending the output document over a network to production equipment configured to generate the tangible voucher from the output document.

13. The method of claim 12, wherein the markup language document is an extensible markup language (“XML”) document.

14. The method of claim 12, wherein the collection of template rules are included in an extensible stylesheet language transformations (“XSLT”) stylesheet.

15. The method of claim 12, wherein the formatted markup language document is an extensible stylesheet language (“XSL”)-formatting objects (“FO”) document.

16. The method of claim 12, wherein the output document is a portable document format (“PDF”) document or a PostScript document.

17. A non-transitory computer readable medium having computer-executable instructions stored thereon that are executable by a computing device to perform the method of claim 12.

18-34. (canceled)
